(19) United States
(12) Patent Application Publication
(10) Pub. No.: US 2021/0379970 A1
(43) Pub. Date: Dec. 9, 2021

(54) FULLY EMBEDDED PICKUP TRUCK BED COVER

(71) Applicant: NINGBO KUATU ELECTRONIC TECH. CO. LTD., Ningbo (CN)

(72) Inventors: YUNYAN HE, NINGBO (CN); GUANQIAN GU, NINGBO (CN); JIANPING LUO, NINGBO (CN)

(73) Assignee: NINGBO KUATU ELECTRONIC TECH. CO. LTD.

(21) Appl. No.: 16/922,870

(22) Filed: Jul. 7, 2020

(30) Foreign Application Priority Data
Jun. 9, 2020 (CN) 202010518263.7

(51) Int. Cl. B60J 7/04; B60J 7/19; B60J 10/90; B60J 10/27; B60J 10/36

(52) U.S. Cl. CPC B60J 7/042; B60J 7/198; B60J 10/36; B60J 10/27; B60J 10/90

(57) ABSTRACT

The invention is relevant to the field of machinery, in particular to a bed cover of vehicle. A fully embedded cover of pick-up truck includes a rail device which is fixed to the inner wall of the hopper of the pickup truck, a front bar, four cover plates, a rear bar and four locks. This invention provides the pickup truck a newly designed fully embedded bed cover which is convenient to use. In this design, the structure of the front bar, the cover plate and the rear bar formed a seal bed cover, so as to prevent rainwater permeating into the cargo hopper. Since the bed cover is built in the cargo hopper, the car body is relatively flat, thus improving the user's use experience.

### CROSS-REFERENCE TO RELATED APPLICATIONS

This application claims priority to Chinese Patent Application No. 202010518263.7 with a filing date of Jun. 9, 2020. The content of the aforementioned application, including any intervening amendments thereto, are incorporated herein by reference.

### TECHNICAL FIELD

This invention is relevant to mechanical field, especially about the bed cover of pickup truck.

### BACKGROUND

Pickup, also known as the sedan truck, has a cargo hopper for loading goods; however, the cargo hopper is open. In order to preventing the water from hitting the goods inside in rainy and snowy weather, people design a bed cover for the hopper of the pickup and installed the cover on the cargo hopper of pickup. The bed cover is used to cover the goods in the hopper to prevent the goods inside from getting wet by rain. However, the effect of the existing car cover is not so good. The existing car cover often install a number of reversible cover plates on a frame through hinges and other structures, that makes many gaps between the cover plates and water drops from where the will leak into the hopper. Moreover, the consistency between the car cover and the hopper is poor because it is an external structure.

### SUMMARY OF THE INVENTION

The purpose of the invention is to provide a kind of fully embedded cover of pick-up truck and solve at least one technical problem above.

Thus the invention use the following method:

A fully embedded cover of pick-up truck includes one bed cover. Its features are that the bed cover includes a rail device fixed to the inner wall of the pickup truck, a front bar, four cover plates, a rear bar and four lock devices; four cover plates include a first cover plate, a second cover plate, a third cover plate and a fourth cover plate, wherein said front bar, first plate, second plate, third plate, fourth plate and the rear bar are placed from front to back in sequence; the front bar is connected with the first cover plate through a first rotating shaft structure, the first cover plate is connected with the second cover plate through a second rotating shaft structure, the second cover plate is connected with the third cover plate through a third rotating shaft structure, the third cover plate is connected with the fourth cover plate through a fourth rotating shaft structure, and the rear bar is fixed to the fourth cover plate.

There is a latch device under the front bar which used to connect the guide rail device; four lock buckle devices are respectively arranged under the second shaft structure, the third shaft structure, the fourth shaft structure and the rear bar, so as to connect the second shaft structure, thus fix the second shaft structure, the third shaft structure, the fourth shaft structure and the rear bar to the guide rail device.

Both sides of the first cover plate, the second cover plate, the third cover plate and the fourth cover plate are equipped with a side rail.

The lower part of the front bar is provided with a first shark fin shaped rubber strip for waterproofing, the first shark fin shaped strip includes a first sheet rubber strip with an arc cross section and at least two obliquely arranged second sheet rubber strips; the length of the first sheet rubber strip is longer than the second sheet rubber strips and it is placed at the front side of the second; both first sheet rubber strip and at least two second sheet rubber strips are evenly arranged at the lower side of the front bar; the lower part of the rear bar is provided with a second shark fin shaped rubber strip for waterproofing, the second shark fin shaped strip includes a third sheet rubber strip with an arc cross section and at least two obliquely arranged fourth sheet rubber strips; the length of the third sheet rubber strip is longer than the fourth sheet rubber strips and it is placed at the front side of the second; both third sheet rubber strip and at least two fourth sheet rubber strips are evenly arranged at the lower side of the rear bar; Wherein said first rotating shaft structure includes a first connector, a first waterproof rubber strip; the rear side part of the first connector is provided with a first embedded groove for connecting the first cover plate; the front side part of the first connecting part is provided with a first rotating groove whose cross section is major arc shape, there is a first straight rod arranged transversely above the groove, the straight rod and the first connect board are connect by a obliquely placed first connector and the first straight rod is used as the first rotating shaft; the first rotating shaft far away from the first connector is provided with a first convexity; the rear side of the front bar is provided with a first rotating hook with a cross section of hook shape, one side of the first hook is embedded into the first rotating groove, the first rotating hook is provided with a second convexity for clamping the first convexity; the first waterproof rubber strip includes a first sheet strip with a first connecting piece on both ends of its lower part, the first connecting piece is provided with a first clip with a cross section of “T” shape, the rear side part of the front bar and the front side part of the first connector are provided with a first groove for clamping the first clip, thus place the first sheet strip above the first rotating shaft.

Wherein said second rotating shaft structure includes a first pedestal, a second connector, a third connector, a second waterproof rubber strip, and a third waterproof rubber strip, the front side part of the second connector is provided with a second embedded groove for connecting the first cover plate while the rear side part of the third connector is provided with a third embedded groove for connecting the second cover plate; the first pedestal is placed between the second and third connector; the front side part of the first pedestal is provided with a second rotating groove whose cross section is major arc shape, there is a second straight rod arranged transversely above the groove, the second straight rod and the first pedestal are connect by a obliquely placed second connecting plate and the second straight rod is used as the second rotating shaft; the second rotating shaft far away from the second connecting piece is provided with a third convexity; the rear side of the second connector is provided with a second rotating hook with a cross section of hook shape, one side of the second rotating hook is embedded into the second rotating groove, the second rotating hook is provided with a fourth convexity for clamping the third convexity; the second waterproof rubber strip includes a second sheet strip, with a second connecting piece on both ends of the lower part, there is a sixth clip with a cross section of “T” shape on the second connecting piece, both the rear side part of the second connector and the front side part of the first pedestal are provided with a second groove for clamping the second clip, thus place the second sheet strip above the second rotating shaft; the rear side part of the first pedestal is provided with a third rotating groove whose cross section is major arc shape, there is a third straight rod arranged transversely above the groove, the third straight rod and the first pedestal are connect by a obliquely placed third connecting plate and the third straight rod is used as the third rotating shaft; the third rotating shaft far away from the third connecting piece is provided with a fifth convexity; the front side of the third connector is provided with a third rotating hook with a cross section of hook shape, one side of the third hook is embedded into the third rotating groove, the third rotating hook is provided with a sixth convexity for clamping the fifth convexity; the third waterproof rubber strip includes a third sheet strip with a third connecting piece on both ends of the lower part, the third connecting piece is provided with a third clip with a cross section of “T” shape, the front side part of the third connector and the rear side part of the first pedestal are provided with a third groove for clamping the second clip, thus place the second sheet strip above the second rotating shaft.

Wherein said third rotating shaft structure includes a second pedestal, a fourth connector, a fifth connector, a fourth waterproof rubber strip, and a fifth waterproof rubber strip; the front side part of the fourth connector is provided with a fourth embedded groove for connecting the second cover plate while the rear side part of the fifth connector is provided with a fifth embedded groove for connecting the third cover plate; the second pedestal is placed between the fourth and fifth connector; the front side part of the second pedestal is provided with a fourth rotating groove whose cross section is major arc shape, there is a fourth straight rod arranged transversely above the groove, the fourth straight rod and the second pedestal are connect by a obliquely placed second connecting plate and the fourth straight rod is used as the fourth rotating shaft; the fourth rotating shaft far away from the fourth connecting piece is provided with a sixth convexity;

the rear side of the fourth connector is provided with a fourth rotating hook with a cross section of hook shape, one side of the fourth hook is embedded into the fourth rotating groove, the fourth rotating hook is provided with a seventh convexity for clamping the sixth convexity; the fourth waterproof rubber strip includes a fourth sheet with a fourth connecting piece on both ends of the lower part, the fourth connecting piece is provided with a fourth clip with a cross section of “T” shape, the rear side part of the fourth connector and the front side part of the second pedestal are provided with a fourth groove for clamping the fourth clip, thus place the fourth sheet strip above the fourth rotating shaft; the rear side part of the second pedestal is provided with a fifth rotating groove whose cross section is major arc shape, there is a fifth straight rod arranged transversely above the groove, the fifth straight rod and the second pedestal are connect by a obliquely placed fifth connecting plate and the fifth straight rod is used as the fifth rotating shaft; the fifth rotating shaft far away from the fifth connecting piece is provided with a eighth convexity; the front side of the fifth connector is provided with a fifth rotating hook with a cross section of hook shape, one side of the fifth hook is embedded into the fifth rotating groove, the fifth rotating hook is provided with a ninth convexity for clamping the eighth convexity; the fifth waterproof rubber strip includes a fifth sheet strip with a third connecting piece on both ends of the lower part, the fifth connecting piece is provided with a fifth clip with a cross section of “T” shape, the front side part of the fifth connector and the rear side part of the second pedestal are provided with a fifth groove for clamping the fifth clip, thus place the fifth sheet strip above the fifth rotating shaft; wherein said fourth shaft structure includes the sixth waterproof rubber strip, the sixth connector and the seventh connector; the front side part of the sixth connector is provided with a sixth embedded groove for clamping the third cover plate, the rear side part of the seventh connector is provided with a seventh embedded groove for clamping the fourth cover plate; the sixth waterproof rubber strip is placed between the sixth and seventh connector; the sixth waterproof rubber strip includes a sixth sheet with a sixth connecting piece on both ends of the lower part, the sixth connecting piece is provided with a sixth clip with a cross section of “T” shape, the rear side part of the sixth connector and the front side part of the seventh connector are provided with a six groove for clamping the sixth clip; wherein, the length of the second rotating shaft structure is longer than the length of the third rotating shaft structure.

Wherein, the upper part of the front bar is provided with two buckle devices for binding and two buckle devices are respectively arranged on both sides of the front bar; the buckle device includes a pedestal and a buckle; the buckle device includes a pedestal plate, a fixed rod on the pedestal plate, a fixed frame on the fixed rod and a hole for passing through the strap is arranged on the fixed frame; the pedestal is provided with a fixed groove, a guide groove and a upward inclined spring piece, the fixing groove is connected with the guide groove, the pedestal plate is arranged in the fixing groove, one side part of the spring plate is fixed in the guide groove while the other side is against the lower surface of the bottom plate.

Wherein, the lock device includes two square tube shaped lock sleeves, a steel wire-rope, two lock sleeves include the first lock sleeve and the second lock sleeve, the steel wire rope passes through the first lock sleeve and the second lock sleeve; the first lock sleeve is provided with a first locking tab, a first spring and a first guide ring, the first locking tab is arranged on one side of the first lock sleeve far away from the second lock sleeve, and the first guide ring is fixed on the inner wall of the first lock sleeve; the second lock sleeve is provided with a second locking tab, a second spring and a second guide ring, the second locking tab is arranged on one side of the second lock sleeve far away from the first lock sleeve, and the second guide ring is fixed on the inner wall of the second lock sleeve; one end of the steel wire-rope passes through the first guide ring and fixed to the first locking tab, and the other end passes through the second guide ring and fixed to the second locking tab; there is a first spring sleeve outside the steel wire rope, the first spring is arranged between the first locking tab and the first guide ring, the second spring sleeve is arranged on the outside of the steel wire rope, the second spring is arranged between the second locking tab and the second guide ring; on one side of the first locking sleeve has a first strip slot where two first guide pulleys are placed abreast; the steel wire rope has a first belt, the first belt is arranged between the two first guide pulleys, one side of the first belt extend out from the first strip slot; there is a second strip slot on one side of the first locking sleeve where two second guide pulleys are placed abreast; the steel wire rope has a second belt, the second belt is arranged between the two second guide pulleys, one side of the second belt extend out from the second strip slot.

Wherein, the guide rail device includes two guide rails which are installed on the inner wall of the cargo hopper of the pickup truck. A mounting bracket is arranged on the guide rail, a strip groove with a support rod is arranged on the mounting bracket, one side of the support set is provided with a thread hole which connected to the strip groove and a fixed threaded rod passes through it; a rod is arranged at both sides of the first rotating shaft structure, the end of the support rod is design as a ball joint; a ball joint set for embedding the ball joint is arranged on one side of the support rod.

Wherein, there is a waterproof strip attached to one side of the guide rail near the bed cover. When the car cover is in use, the side railings are compressed with waterproof strips to form a sealed space and play a waterproof role.

There is a waterproof strip pasted on one side of the guide rail near the bed cover.

Through this design, the invention provides a fully embedded car cover for the pickup truck which is convenient to use. In this design, the car cover is installed in the cargo hopper of the pickup truck as a whole, and the structure of the front bar, the cover plate and the back rail formed a sealed space, thus prevent the goods inside from rain. Furthermore, the car body is relatively flat since the bed cover is built in the cargo hopper, thus improve the user's use experience.

### BRIEF DESCRIPTION OF THE DRAWINGS

FIG. 1 is a partial structure illustration of the invention

FIG. 2 is the bottom view of the partial structure of the invention

FIG. 3 is a partial structure section illustration of the invention

FIG. 4 is a partial structure section illustration of the first waterproof adhesive strip in the invention

FIG. 5 is a partial structure section illustration of the first shaft structure in the invention

FIG. 6 is a partial structure section illustration of the second shaft structure in the invention

FIG. 7 is a partial structure section illustration of the third shaft structure in the invention

FIG. 8 is a partial structure section illustration of the forth shaft structure in the invention

FIG. 9 is a partial structure decomposition illustration of the third shaft structure in the invention

FIG. 10 is a partial structure section illustration of the latch device in the invention

FIG. 11 is a partial structure section illustration of the lock buckle device in the invention

FIG. 12 is a partial structure decomposition illustration of the first lock buckle in the invention

FIG. 13 is a partial structure section illustration of the guide rail device in the invention

FIG. 14 is a partial structure illustration of the invention after folding

FIG. 15 is a partial structure illustration of the buckle device in the invention

FIG. 16 is an use status illustration of the invention after folding

### DETAILED DESCRIPTION OF THE PREFERRED EMBODIMENTS

The following instruction is to further explain the concrete implementation method of the invention.

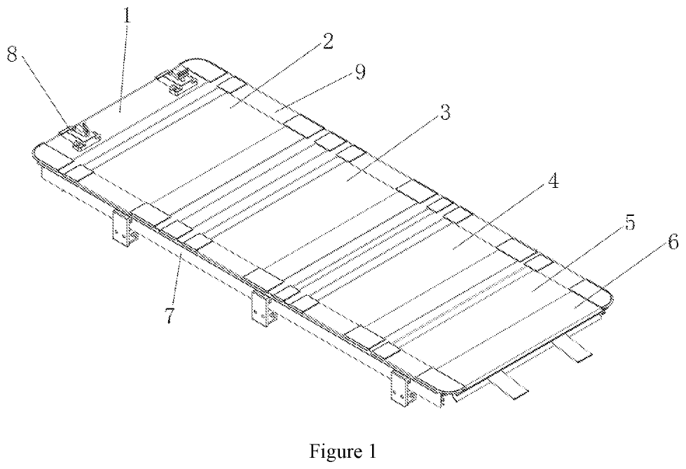

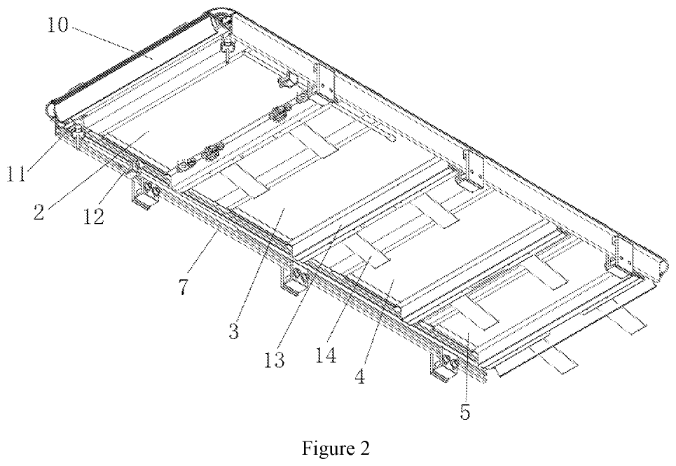

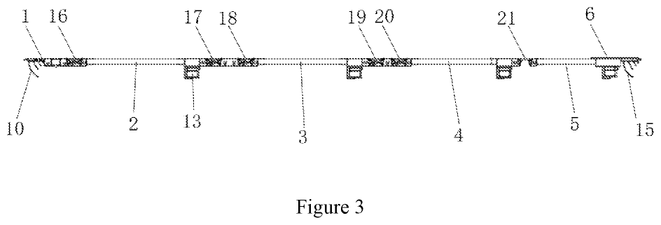

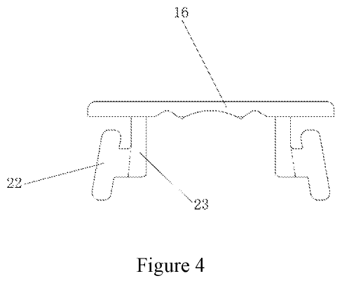

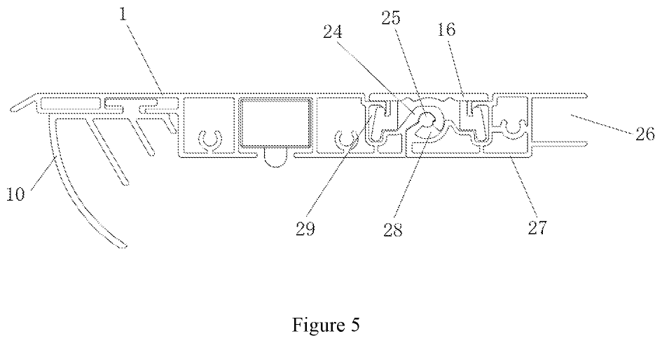

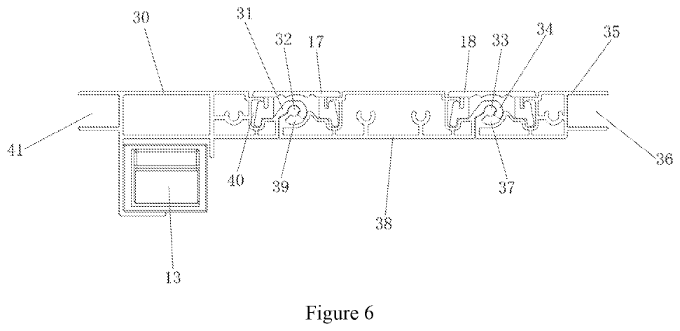

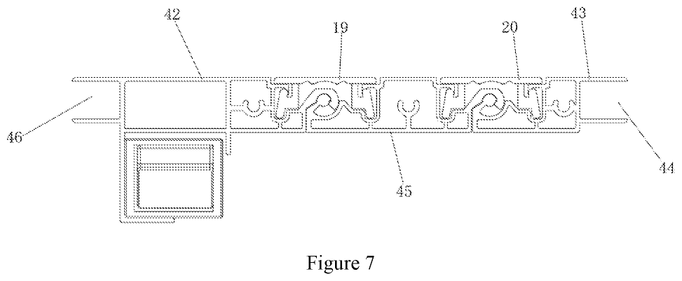

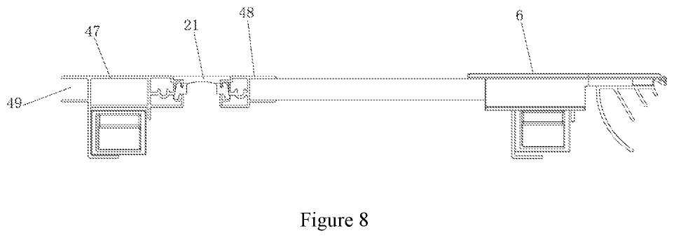

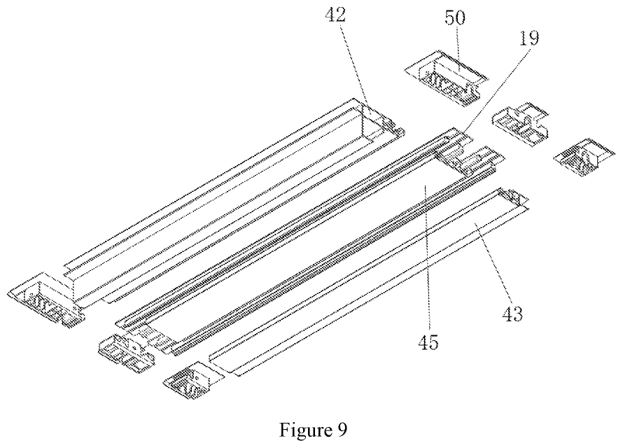

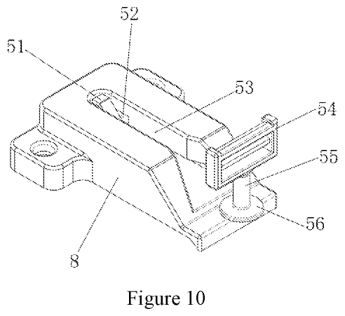

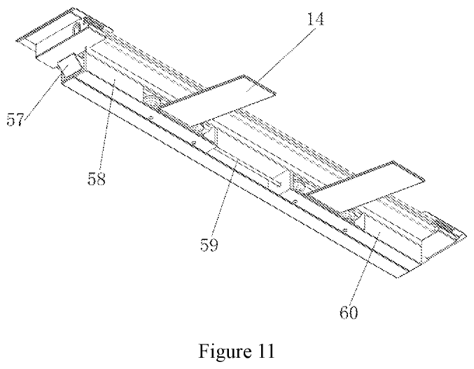

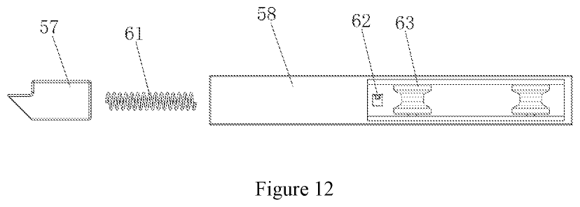

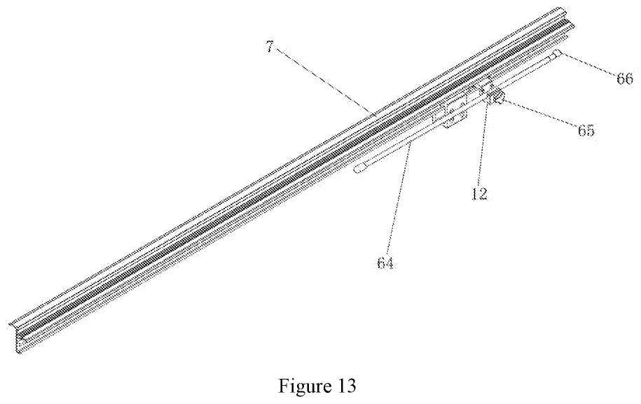

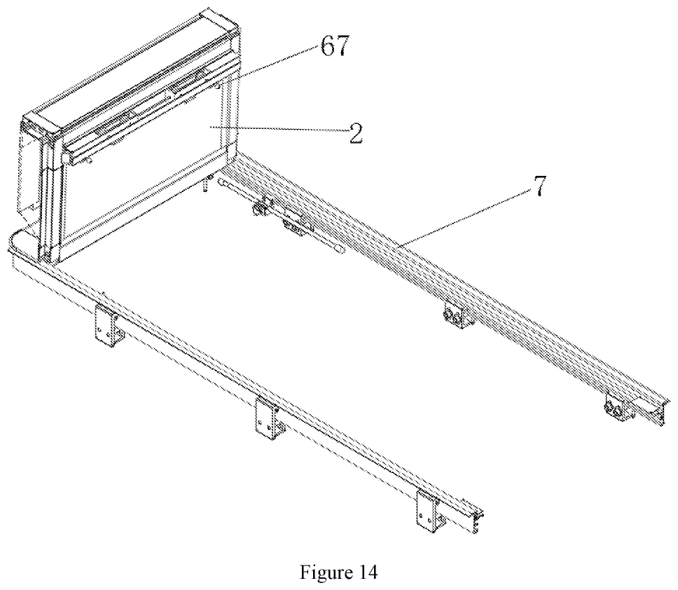

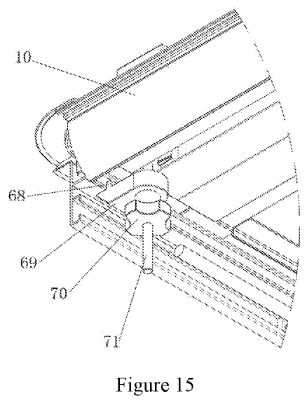

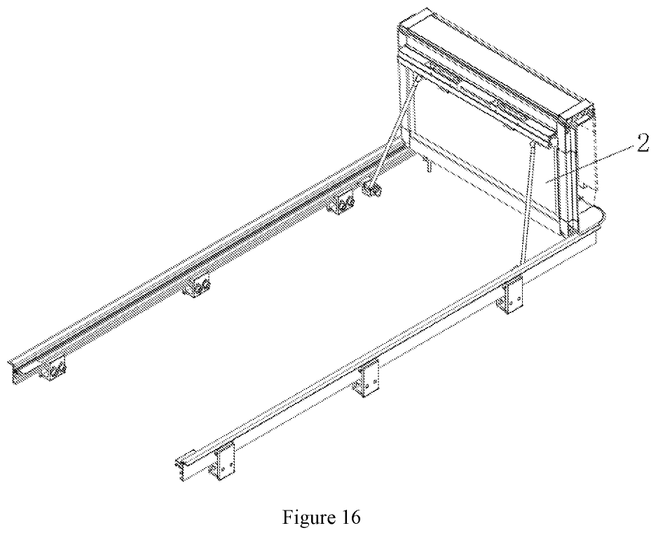

As is seen from FIGS. 1 to 16, a fully embedded cover of pick-up truck includes one bed cover. The bed cover includes a guide rail device 7 which is fixed to the inner wall of the hopper of the pickup truck, a front bar 1, four cover plates, a rear barb and four lock buckles 13. Four cover plates include a first plate 2, a second plate 3, a third plate 4, a fourth plate 5 while the front bar, the first plate, the second plate, the third plate and the rear bar are placed from front to back in sequence; the front bar is connected with the first cover plate through a first rotating shaft structure, the first cover plate is connected with the second cover plate through a second rotating shaft structure, the second cover plate is connected with the third cover plate through a third rotating shaft structure, the third cover plate is connected with the fourth cover plate through a fourth rotating shaft structure, and the rear bar is fixed to the fourth cover plate; there is a latch device 11 under the front bar which is used to connect the guide rail device; four lock buckle devices 13 are respectively arranged under the second shaft structure, the third shaft structure, the fourth shaft structure and the rear bar, so as to connect the second shaft structure, the third shaft structure, the fourth shaft structure and the rear bar to the guide rail device. This invention provides a fully embedded bed cover for the pickup truck which is convenient to use. In this design, the structure of the front bar, the cover plate and the back rail form a seal bed cover, so as to prevent rainwater permeating into the cargo hopper. Since the bed cover is built in the cargo hopper, the car body is relatively flat, thus improving the user's use experience.

Both sides of the first cover plate, the second cover plate, the third cover plate and the fourth cover plate are equipped with side rails 9 which wrap the two sides of the cover plate to fix the cover plate, thus forming the longitudinal framework of the cover plate and increasing the structural strength.

The lower part of the front bar is provided with a first shark fin shaped rubber strip 10 for waterproofing. The first shark fin shaped strip includes a first sheet rubber strip with an arc cross section and at least two second sheet rubber strips which arranged obliquely, the length of the first sheet rubber strip is longer than the second sheet rubber strips and it is placed at the front side of the second, both first sheet rubber strip and at least two second sheet rubber strips are evenly arranged at the lower side of the front bar; the lower part of the rear bar is provided with a second shark fin shaped rubber strip 15 for waterproofing. The second shark fin shaped strip includes a third sheet rubber strip with an arc cross section and at least two obliquely arranged fourth sheet rubber strips, the length of the third sheet rubber strip is longer than the fourth sheet rubber strips and it is placed at the front side of the second, both third sheet rubber strip and at least two fourth sheet rubber strips are evenly arranged at the lower side of the rear bar. The first shark fin rubber strip and the second shark fin rubber strip have waterproof effect on both front and rear sides.

A first end cap is placed on both sides of the front bar with a first waterproof pad on the bottom, a second end cap is placed on both sides of the front bar with a second waterproof pad on the bottom. The first waterproof pad and the first shark fin rubber strip are used together to prevent rain from infiltrating into the cargo hopper from the gap on both sides of the front bar; the second waterproof pad and the first shark fin rubber strip are used together to prevent rain from infiltrating into the cargo hopper from the gap on both sides of the rear bar.

The first rotating shaft structure includes a first connector 27 and a first waterproof rubber strip 16. The rear side part of the first connector is provided with a first embedded groove 26 for connecting the first cover plate; the front side part of the first connecting part is provided with a first rotating groove 28 whose cross section is major arc shape, there is a first straight rod arranged transversely above the groove, the straight rod and the first connect board are connect by a obliquely placed first connector and the first straight rod is used as the first rotating shaft 25; the first rotating shaft far away from the first connector is provided with a first convexity; the rear side of the front bar is provided with a first rotating hook 24 with a cross section of hook shape, one side of the first hook is embedded into the first rotating groove, the first rotating hook is provided with a second convexity for clamping the first convexity; the first waterproof rubber strip includes a first sheet with a first connecting piece 22 on both ends of the lower part, there is a first clip with a cross section of “T” shape on the first connecting piece, the rear side part of the front bar and the front side part of the first connector are provided with a first groove 29 for clamping the first clip, thus place the first sheet strip above the first rotating shaft. The first straight rod includes the upper part and the lower part, the cross sections of the upper part and the lower part are semi-circular, the radius of the upper part of the first straight rod is larger than that of the lower part, thus make the first convexity on the first rotation shaft far away from the first connecting plate. The cross section of the first clamping groove is in the shape of “C”.

The second rotating shaft structure includes a first pedestal 38, a second connector 30, a third connector 35, a second waterproof rubber strip 17, and a third waterproof rubber strip 18, the front side part of the second connector is provided with a second embedded groove 41 for connecting the first cover plate while the rear side part of the third connector is provided with a third embedded groove 36 for connecting the second cover plate; the first pedestal is placed between the second and third connector; the front side part of the first pedestal is provided with a second rotating groove 39 whose cross section is major arc shape, there is a second straight rod arranged transversely above the groove, the second straight rod and the first pedestal are connect by a obliquely placed second connecting plate and the second straight rod is used as the second rotating shaft 32; the second rotating shaft far away from the second connecting piece is provided with a third convexity; the rear side of the second connector is provided with a second rotating hook 31 with a cross section of hook shape, one side of the second hook is embedded into the second rotating groove, the second rotating hook is provided with a fourth convexity for clamping the third convexity; the second waterproof rubber strip includes a second sheet with a second connecting piece 22 on both ends of the lower part, the second connecting piece is provided with a “T” shape second clip, the rear side part of the second connector and the front side part of the first pedestal are provided with a second groove 40 for clamping the second clip, thus place the second sheet above the second rotating shaft; the rear side part of the first pedestal is provided with a third rotating groove 37 whose cross section is major arc shape, there is a third straight rod arranged transversely above the groove, the third straight rod and the first pedestal are connected by a obliquely placed third connecting plate and the third straight rod is used as the third rotating shaft 33; the third rotating shaft far away from the third connecting piece is provided with a fifth convexity; the front side of the third connector is provided with a third rotating hook 34 with a cross section of hook shape, one side of the third hook is embedded into the third rotating groove, the third rotating hook is provided with a sixth convexity for clamping the fifth convexity; the third waterproof rubber strip includes a third sheet strip with a third connecting piece on both ends of the lower part, the third connecting piece is provided with a “T” shape third clip, the front side part of the third connector and the rear side part of the first pedestal are provided with a third groove 40 for clamping the third clip, thus place the third sheet strip above the second rotating shaft. Similarly, the second straight rod includes the upper part and the lower part, the cross section of the upper part and the lower part of the second straight rod are both semi-circular, the radius of the upper part of the second straight rod is larger than that of the lower part, and thus form the third convexity on the second rotation shaft far away from the second connecting plate; the third straight rod includes the upper part and the lower part, the radius of the upper part of the third straight rod is larger than that of the lower part, and thus make the fifth convexity on the third rotation shaft far away from the third connecting plate.

The structure of the third rotating shaft is the same as the second rotating shaft, which includes a second pedestal 45, a fourth connector 42, a fifth connector 43, a fourth waterproof rubber strip 19, and a fifth waterproof rubber strip 20, the front side part of the fourth connector is provided with a fourth embedded groove 46 for connecting the second cover plate while the rear side part of the fifth connector is provided with a fifth embedded groove 44 for connecting the third cover plate; the second pedestal is placed between the fourth and fifth connector; the front side part of the second pedestal is provided with a fourth rotating groove whose cross section is major arc shape, there is a fourth straight rod arranged transversely above the groove, the fourth straight rod and the second pedestal are connect by a obliquely placed second connecting plate and the fourth straight rod is used as the fourth rotating shaft; the fourth rotating shaft far away from the fourth connecting piece is provided with a sixth convexity; the rear side of the fourth connector is provided with a fourth rotating hook with a cross section of hook shape, one side of the fourth hook is embedded into the fourth rotating groove, the fourth rotating hook is provided with a seventh convexity for clamping the sixth convexity; the fourth waterproof rubber strip includes a fourth sheet strip with a fourth connecting piece on both ends of the lower part, there is a fourth foot with a cross section of “T” on the fourth connecting piece, the rear side part of the fourth connector and the front side part of the second pedestal are provided with a fourth groove for clamping the fourth clip, then place the fourth sheet above the fourth rotating shaft. The rear side part of the second pedestal is provided with a fifth rotating groove whose cross section is major arc shape, there is a fifth straight rod arranged transversely above the groove, the fifth straight rod and the second pedestal are connect by a obliquely placed fifth connecting plate and the fifth straight rod is as the fifth rotating shaft; the fifth rotating shaft far away from the fifth connecting piece is provided with a eighth convexity; the front side of the fifth connector is provided with a fifth rotating hook with a cross section of hook shape, one side of the fifth hook is embedded into the fifth rotating groove, the fifth rotating hook is provided with a ninth convexity for clamping the eighth convexity; the fifth waterproof rubber strip includes a fifth sheet strip with a third connecting piece on both ends of the lower part, there is a fifth clip with a cross section of “T” on the fifth connecting piece, the front side part of the fifth connector and the rear side part of the second pedestal are provided with a fifth groove for clamping the fifth clip, thus place the fifth sheet strip above the fifth rotating shaft. Similarly, the fourth straight rod includes the upper part and the lower part. The cross section of the upper part and the lower part of the fourth straight rod are both semi-circular. The radius of the upper part of the fourth straight rod is larger than that of the lower part, thus form the sixth convexity on the fourth rotation shaft far away from the fourth connecting plate; the fifth straight rod includes the upper part and the lower part, the radius of the upper part of the fifth straight rod is larger than that of the lower part, thus form the eighth convexity on the fifth rotation shaft far away from the fifth connecting plate. The first rotating shaft structure, the second rotating shaft structure and the third rotating shaft structure adopt a unique waterproof rubber strip, which not only ensures the waterproof effect of the rotating shaft structure, but also increases the strength of the connection.

The fourth shaft structure includes a sixth waterproof rubber strip 21, a sixth connector 47, a seventh connector 48, the front side part of the sixth connector is provided with a sixth embedded groove 49 for clamping the third cover plate, the rear side part of the seventh connector is provided with a seventh embedded groove for clamping the fourth cover plate; the sixth waterproof rubber strip is placed between the sixth and seventh connector; the sixth waterproof rubber strip includes a sixth sheet with a sixth connecting piece on both ends of the lower part, there is a T shape sixth clip on the sixth connecting piece, the rear side part of the sixth connector and the front side part of the seventh connector are provided with a six groove for clamping the sixth clip. Through the flexible connection of the sixth waterproof rubber strip, the fourth cover plate can be rotated for more than 180 degrees without using a rotating shaft, so as to make it closer to the third cover plate after turning over, and helps the further folding of the third cover plate, thus reduce the volume of the car cover after folding, thus, so as to make it more convenient for the user to put in or take out the goods from the hopper of the pickup truck.

In order to facilitate and fix the rear bar and the fourth cover plate, there is an eighth embedding groove on the front side of the rear bar for connecting the fourth cover plate.

In order to facilitate turning and folding the bed cover, the length of the second rotating shaft structure is longer than the length of the third rotating shaft structure. In this design, the bed cover can be turned over and folded through the first rotating shaft structure, the second rotating shaft structure, the third rotating shaft structure and the fourth rotating shaft structure. Users turn over the fourth cover plate, the third cover plate, the second cover plate and the first cover plate in order, so that place the four cover plate above the front bar in order, thus, greatly reduces the volume after the cover is folded, and it is convenient for the user to use the hopper of the pickup truck.

In order to ensure the use effect of the bed cover, both sides of the first connector, the first pedestal, the second connector, the third connector, the second pedestal, the fourth connector, the fifth connector, the sixth connector and the seventh connector are provided with a third end cap 50. The third end cap is equal with the side bar and fixed by bolts. Both ends of the first waterproof rubber strip, the second waterproof rubber strip, the third waterproof rubber strip, the fourth waterproof rubber strip, the fifth waterproof rubber strip and the sixth waterproof rubber strip, which is located in the first rotating shaft structure, the second rotating shaft structure, the third rotating shaft structure and the fourth rotating shaft structure, are fixed to the lower surface of the third end cap by glue.

The upper part of the front bar is provided with two buckle devices 8 for binding and two buckle devices are respectively arranged on both sides of the front bar; the buckle device includes a pedestal and a buckle; the buckle device includes a pedestal plate 56, there is a fixed rod 55 on the pedestal plate, on which there is a fixed frame 54 using for passing through the strap; the pedestal is iii provided with a fixed groove 52, a guide groove 53 and a upward inclined spring piece 51, the fixing groove connects the guide groove, the pedestal plate is arranged in the fixing groove, one side part of the spring plate is fixed in the guide groove while the other side is against the lower surface of the bottom plate. The pedestal can be bolted to the front bar. Through the strap passing through the buckle device, the folded car cover can be further fixed to avoid falling off. In order to facilitate the buckle to slide in or out of the fixed groove through the guide groove, the width of the upper part of the guide groove is larger than the width of the fixed rod, and the width of the lower part of the guide groove is larger than the width of the pedestal plate; the cross section of the pedestal plate and the fixed groove are both circular; the position of the fixed groove on the pedestal is higher than the guide groove. When the buckle device in this design is used, the buckle slides into the fixing groove of the pedestal along the guide groove, and and the spring piece is pressed under the bottom plate of the buckle. When the bottom plate under the buckle slides into the fixing groove, the spring piece against the bottom plate makes buckle fixed in the groove, so that the buckle will not fall off; When you need to unlock the buckle, press the buckle down so that the bottom plate presses the spring plate and moves downward, so that the pedestal plate will release from the fixed groove and slide out of the guide groove.

The lock device includes two square tube shaped lock sleeves, a steel wirerope 59, two lock sleeves include the first lock sleeve and the second lock sleeve, the steel wire-rope passes through the first lock sleeve 58 and the second lock sleeve 60; the first lock sleeve is provided with a first locking tab 57, a first spring 61 and a first guide ring 62, the first locking tab is arranged on one side of the first lock sleeve far away from the second lock sleeve, the first guide ring is fixed on the inner wall of the first lock sleeve; the second lock sleeve is provided with a second locking tab, a second spring and a second guide ring, the second locking tab is arranged on one side of the second lock sleeve far away from the first lock sleeve, the second guide ring is fixed on the inner wall of the second lock sleeve; one end of the steel wire-rope passes through the first guide ring and fixed to the first locking tab, meanwhile the other end of the steel wire rope passes through the second guide ring and fixed to the second locking tab; the first spring covers outside the steel wire rope, the first spring is arranged between the first locking tab and the first guide ring, the second spring covers outside the steel wire rope, the second spring is arranged between the second locking tab and the second guide ring; the first strip slot is on one side of the first locking sleeve at where two first guide pulleys 63 are placed abreast; the steel wire rope has a first belt 14, the first belt is arranged between the two first guide pulleys and one end of the first belt extend out from the first strip slot;

the second strip slot is on one side of the second locking sleeve at where two second guide pulleys placed abreast; the steel wire rope has a second belt, the second belt is arranged between the two second guide pulleys and one end of the second belt goes out from the second strip slot;

the steel wire rope connects the first and the second lock sleeves in series, the first guide pulley and the second guide pulley are fixed in the first and the second lock sleeves respectively through pins; one end of steel wire rope passes the first guide pulley, and then passes through the first guide ring and the first spring and finally fixed on the first locking tab, the two ends of the first spring are separated against the first guide ring and the first locking tab; the other end of the steel wire rope passes the second guide pulley, then the second guide ring and the second spring and finally fixed on the second locking tab, the two ends of the second spring are separated against the second guide ring and the second locking tab. A first installation ring is arranged on the first locking tab, when one end of the steel wire rope extends into the first installation ring, bent and flattened the top of the steel wire rope to make the flattened wire rope head larger than the inner diameter of the first installation ring, so as to fix one end of the steel wire rope in the first lock tab; similarly, the second locking tab is provided with a second installation ring, when then other end of the steel wire rope extends into the second installation ring, bent and flattened the top of the steel wire rope to make the flattened wire rope head larger than the inner diameter of the second installation ring, so as to fix the other end of the steel wire rope in the second lock tab. The bottom of the second rotating shaft structure, the third rotating shaft structure, the fourth rotating shaft structure and rear bar are all provided with a lock device installation groove, and the first lock sleeve and the second lock sleeve are arranged in the installation groove. When pulling outwards the belt, the steel wire rope is driven to tighten, so that the first locking tab and the second locking tab are respectively retracted into the first locking sleeve and the second locking sleeve, and the first locking tab and the second locking tab are no longer stuck in the guide rail device, so that the user can turn over the cover; due to the elastic effect of the first spring and the second spring when releasing the belt, one side of the first and second locking tab shall slide out of the first and second locking tab, so as to clamp the guide rail device and complete the action of locking the car cover.

The guide rail device includes two guide rails which are installed on the inner wall of the cargo hopper of the pickup truck. A mounting bracket 12 is arranged on the guide rail, there is a strip groove on the mounting bracket at where placed a support rod 64, one side of the support set is provided with a thread hole 29 which connected to the strip groove and a fixed threaded rod 65 passes through it; a rod is arranged at both sides of the first rotating shaft structure, the end of the support rod is design as a ball joint 67; a ball joint set 66 for embedding the ball joint is arranged on one side of the support rod. The support rod can be fixed on both sides of the first connector. When the bed cover is folded for use, the user can take off the support rod, and clip the ball joint into the ball joint set on one side of the support rod. The connection of the ball joint and the ball joint set make it more convenient for the user to install the support rod. The user then places the other side of the support rod into the strip groove of the support set. By tightening the fixing screw, the fixing bolt compresses the support rod and fixes it, so that the support rod can be used to support and fix the car cover against the overturned car cover; when the support rod is not used, the support rod can be horizontally placed at the strip groove of the support set, and then fix the support rod by fixing bolts.

A ball head set is arranged on one side of the support rod, the other side of the support rod is provided with an elastic plug made of elastic material to compress the fixing bolt and fix the support rod. A waterproof strip is pasted on one side of the guide rail near the bed cover. When the car cover is in use, the side railings will compressing waterproof strips to form a sealed space and play a waterproof role. In order to ensure the firmness of the guide rail, a clamp component is used to fix the guide rail on the inner wall of the hopper of the pickup truck, the upper part of the component clamps the lower part of the guide rail, and the lower part is fixed to the inner wall of the hopper of the pickup truck by bolts.

The buckle device includes a screw 71 and a fixing block 69, there is a through hole on one side of the fixing block through where the screw passed and fixed at the lower side of the front bar, there is a plum nut 70 is on the screw, the fixing block is arranged above the nut and the other side extends into the slide groove of the guide rail. When tightening the nut, the fixing block is pushed up to make the fixing block press the guide rail tightly, and the front bar is tightened and fixed by the screw, so as to make the bed cover more stable. When the lower part of the guide rail device is fixed by the clamp component, the guide rail device may easily incline inward, and the fixing block of the buckle device against the guide rail corrects the inwardness of the guide rail device. A block of convexity 68 is arranged on the fixing block extending into the sliding groove of the guide rail through which the fixed block increases the contact area with the sliding groove of the guide rail, so as to increase the friction between the fixed block and the guide rail by the block convexity, and further improve the stability of the installation of the front bar.

Finally, it should be noted that the above is only a preferred embodiment of the invention and is not used to limit the invention. Although the invention is described in detail with reference to the above embodiment, it is still possible for those skilled in the field to modify. Or they can do equivalent replacement of some of the technical features in it. Any modification, equivalent replacement, improvement etc. made within the spirit and principles of the invention shall be included in the scope of protection of the invention.

We claim:

1. A fully embedded bed cover of pickup truck includes one bed cover, wherein:
the bed cover includes a rail device fixed to the inner wall of the pickup truck, a front bar, four cover plates, a rear bar and four lock devices;
four cover plates include a first cover plate, a second cover plate, a third cover plate and a fourth cover plate, the said front bar, first plate, second plate, third plate, fourth plate and the rear bar are placed from front to back in sequence;
the front bar is connected with the first cover plate through a first rotating shaft structure, the first cover plate is connected with the second cover plate through a second rotating shaft structure, the second cover plate is connected with the third cover plate through a third rotating shaft structure, the third cover plate is connected with the fourth cover plate through a fourth rotating shaft structure, and the rear bar is fixed to the fourth cover plate;
there is a latch device under the front bar which used to connect the guide rail device;
four lock buckle devices are respectively arranged under the second shaft structure, the third shaft structure, the fourth shaft structure and the rear bar, so as to connect the second shaft structure, thus fix the second shaft structure, the third shaft structure, the fourth shaft structure and the rear bar to the guide rail device.

2. The fully embedded bed cover for the pickup truck according to claim 1, wherein: the both sides of the first cover plate, the second cover plate, the third cover plate and the fourth cover plate are equipped with a side rail.

3. The fully embedded bed cover for the pickup truck according to claim 1, wherein: the lower part of the front bar is provided with a first shark fin shaped rubber strip for waterproofing, the first shark fin shaped strip includes a first sheet rubber strip with an arc cross section and at least two obliquely arranged second sheet rubber strips; the length of the first sheet rubber strip is longer than the second sheet rubber strips and it is placed at the front side of the second; both first sheet rubber strip and at least two second sheet rubber strips are evenly arranged at the lower side of the front bar;
the lower part of the rear bar is provided with a second shark fin shaped rubber strip for waterproofing, the second shark fin shaped strip includes a third sheet rubber strip with an arc cross section and at least two obliquely arranged fourth sheet rubber strips; the length of the third sheet rubber strip is longer than the fourth sheet rubber strips and it is placed at the front side of the second; both third sheet rubber strip and at least two fourth sheet rubber strips are evenly arranged at the lower side of the rear bar.

4. The fully embedded bed cover for the pickup truck according to claim 1, wherein: said first rotating shaft structure includes a first connector, a first waterproof rubber strip; the rear side part of the first connector is provided with a first embedded groove for connecting the first cover plate;
the front side part of the first connecting part is provided with a first rotating groove whose cross section is major arc shape, there is a first straight rod arranged transversely above the groove, the straight rod and the first connect board are connect by a obliquely placed first connector and the first straight rod is used as the first rotating shaft;
the first rotating shaft far away from the first connector is provided with a first convexity;
the rear side of the front bar is provided with a first rotating hook with a cross section of hook shape, one side of the first hook is embedded into the first rotating groove, the first rotating hook is provided with a second convexity for clamping the first convexity;
the first waterproof rubber strip includes a first sheet strip with a first connecting piece on both ends of its lower part, the first connecting piece is provided with a first clip with a cross section of “T” shape, the rear side part of the front bar and the front side part of the first connector are provided with a first groove for clamping the first clip, thus place the first sheet strip above the first rotating shaft;
the said second rotating shaft structure includes a first pedestal, a second connector, a third connector, a second waterproof rubber strip, and a third waterproof rubber strip; the front side part of the second connector is provided with a second embedded groove for connecting the first cover plate while the rear side part of the third connector is provided with a third embedded groove for connecting the second cover plate;
the first pedestal is placed between the second and third connector; the front side part of the first pedestal is provided with a second rotating groove whose cross section is major arc shape, there is a second straight rod arranged transversely above the groove, the second straight rod and the first pedestal are connect by a obliquely placed second connecting plate and the second straight rod is used as the second rotating shaft;
the second rotating shaft far away from the second connecting piece is provided with a third convexity;
the rear side of the second connector is provided with a second rotating hook with a cross section of hook shape, one side of the second rotating hook is embedded into the second rotating groove, the second rotating hook is provided with a fourth convexity for clamping the third convexity;
the second waterproof rubber strip includes a second sheet strip, with a second connecting piece on both ends of the lower part, there is a second clip with a cross section of “T” shape on the second connecting piece, both the rear side part of the second connector and the front side part of the first pedestal are provided with a second groove for clamping the second clip, thus place the second sheet strip above the second rotating shaft;
the rear side part of the first pedestal is provided with a third rotating groove whose cross section is major arc shape, there is a third straight rod arranged transversely above the groove, the third straight rod and the first pedestal are connect by a obliquely placed third connecting plate and the third straight rod is used as the third rotating shaft;
the third rotating shaft far away from the third connecting piece is provided with a fifth convexity;
the front side of the third connector is provided with a third rotating hook with a cross section of hook shape, one side of the third hook is embedded into the third rotating groove, the third rotating hook is provided with a sixth convexity for clamping the fifth convexity;
the third waterproof rubber strip includes a third sheet strip with a third connecting piece on both ends of the lower part, there is a third clip with a cross section of a “T” shape on the third connecting piece, the front side part of the third connector and the rear side part of the first pedestal are provided with a third groove for clamping the second clip, thus place the second sheet strip above the second rotating shaft;
the said third rotating shaft structure includes a second pedestal, a fourth connector, a fifth connector, a fourth waterproof rubber strip, and a fifth waterproof rubber strip; the front side part of the fourth connector is provided with a fourth embedded groove for connecting the second cover plate while the rear side part of the fifth connector is provided with a fifth embedded groove for connecting the third cover plate;
the second pedestal is placed between the fourth and fifth connector; the front side part of the second pedestal is provided with a fourth rotating groove whose cross section is major arc shape, there is a fourth straight rod arranged transversely above the groove, the fourth straight rod and the second pedestal are connect by a obliquely placed second connecting plate and the fourth straight rod is used as the fourth rotating shaft;
the fourth rotating shaft far away from the fourth connecting piece is provided with a sixth convexity;
the rear side of the fourth connector is provided with a fourth rotating hook with a cross section of hook shape, one side of the fourth hook is embedded into the fourth rotating groove, the fourth rotating hook is provided with a seventh convexity for clamping the sixth convexity;
the fourth waterproof rubber strip includes a fourth sheet with a fourth connecting piece on both ends of the lower part, there is a fourth clip with a cross section of “T” shape on the fourth connecting piece, the rear side part of the fourth connector and the front side part of the second pedestal are provided with a fourth groove for clamping the fourth clip, thus place the fourth sheet strip above the fourth rotating shaft;
the rear side part of the second pedestal is provided with a fifth rotating groove whose cross section is major arc shape, there is a fifth straight rod arranged transversely above the groove, the fifth straight rod and the second pedestal are connect by a obliquely placed fifth connecting plate and the fifth straight rod is used as the fifth rotating shaft;
the fifth rotating shaft far away from the fifth connecting piece is provided with a eighth convexity;
the front side of the fifth connector is provided with a fifth rotating hook with a cross section of hook shape, one side of the fifth hook is embedded into the fifth rotating groove, the fifth rotating hook is provided with a ninth convexity for clamping the eighth convexity;
the fifth waterproof rubber strip includes a fifth sheet strip with a third connecting piece on both ends of the lower part, there is a fifth clip with a cross section of “T” shape on the fifth connecting piece, the front side part of the fifth connector and the rear side part of the second pedestal are provided with a fifth groove for clamping the fifth clip, thus place the fifth sheet strip above the fifth rotating shaft.

5. The fully embedded bed cover for the pickup truck according to claim 1, wherein: said fourth shaft structure includes the sixth waterproof rubber strip, the sixth connector and the seventh connector; the front side part of the sixth connector is provided with a sixth embedded groove for clamping the third cover plate, the rear side part of the seventh connector is provided with a seventh embedded groove for clamping the fourth cover plate;
the sixth waterproof rubber strip is placed between the sixth and seventh connector;
the sixth waterproof rubber strip includes a sixth sheet with a sixth connecting piece on both ends of the lower part, there is a sixth clip with a cross section of “T” shape on the sixth connecting piece, the rear side part of the sixth connector and the front side part of the seventh connector are provided with a six groove for clamping the sixth clip.

6. The fully embedded bed cover for the pickup truck according to claim 1, wherein: the length of the second rotating shaft structure is longer than the length of the third rotating shaft structure.

7. The fully embedded bed cover for the pickup truck according to claim 1, wherein: the upper part of the front bar is provided with two buckle devices for binding and two buckle devices are respectively arranged on both sides of the front bar;
the buckle device includes a pedestal and a buckle; the buckle device includes a pedestal plate, a fixed rod on the pedestal plate, a fixed frame on the fixed rod and a hole for passing through the strap is arranged on the fixed frame;
the pedestal is provided with a fixed groove, a guide groove and a upward inclined spring piece, the fixing groove is connected with the guide groove, the pedestal plate is arranged in the fixing groove, one side part of the spring plate is fixed in the guide groove while the other side is against the lower surface of the bottom plate.

8. The fully embedded bed cover for the pickup truck according to claim 1, wherein: the lock device includes two square tube shaped lock sleeves, a steel wire-rope, two lock sleeves include the first lock sleeve and the second lock sleeve, the steel wire rope passes through the first lock sleeve and the second lock sleeve;
the first lock sleeve is provided with a first locking tab, a first spring and a first guide ring, the first locking tab is arranged on one side of the first lock sleeve far away from the second lock sleeve, and the first guide ring is fixed on the inner wall of the first lock sleeve;
the second lock sleeve is provided with a second locking tab, a second spring and a second guide ring, the second locking tab is arranged on one side of the second lock sleeve far away from the first lock sleeve, and the second guide ring is fixed on the inner wall of the second lock sleeve;
one end of the steel wire-rope passes through the first guide ring and fixed to the first locking tab, and the other end passes through the second guide ring and fixed to the second locking tab;
there is a first spring sleeve outside the steel wire rope, the first spring is arranged between the first locking tab and the first guide ring, the second spring sleeve is arranged on the outside of the steel wire rope, the second spring is arranged between the second locking tab and the second guide ring;
there is a first strip slot on one side of the first locking sleeve where two first guide pulleys are placed abreast; the steel wire rope has a first belt, the first belt is arranged between the two first guide pulleys, one side of the first belt extend out from the first strip slot;
there is a second strip slot on one side of the first locking sleeve where two second guide pulleys are placed abreast; the steel wire rope has a second belt, the second belt is arranged between the two second guide pulleys, one side of the second belt extend out from the second strip slot.

9. The fully embedded bed cover for the pickup truck according to claim 1, wherein: the guide rail device includes two guide rails which are installed on the inner wall of the cargo hopper of the pickup truck; a mounting bracket is arranged on the guide rail, a strip groove with a support rod is arranged on the mounting bracket, one side of the support set is provided with a thread hole which connected to the strip groove and a fixed threaded rod passes through it;
a rod is arranged at both sides of the first rotating shaft structure, the end of the support rod is design as a ball joint;
a ball joint set for embedding the ball joint is arranged on one side of the support rod.

10. The fully embedded bed cover for the pickup truck according to claim 1, wherein: there is a waterproof strip attached to one side of the guide rail near the bed cover; when the car cover is in use, the side railings are compressed with waterproof strips to form a sealed space and play a waterproof role.
